(19) United States
(12) Patent Application Publication
(10) Pub. No.: US 2004/0030937 A1
(43) Pub. Date: Feb. 12, 2004

(54) Computer remotely controlled by remote controller

(76) Inventors: Ming Chang Wang, Taoyuan City (TW); Chih Wen Liu, Taipei (TW); Wen Hsiung Chang, Yunlin Hsien (TW); Shu Mei Chang, Shu Lin City (TW); Jia Liang Chen, San Chung City (TW)

Correspondence Address: BIRCH STEWART KOLASCH & BIRCH, PO BOX 747, FALLS CHURCH, VA, 22040-0747, US

(21) Appl. No.: 10/216,202

(22) Filed: Aug. 12, 2002

(51) Int. Cl. G06F 1/26

(52) U.S. Cl. 713/300

(57) ABSTRACT

A computer remotely controlled turned on or off by a remote controller is provided. The computer includes a receiver, a microprocessor, a power source management module, an I/O controller, a universal output device, and an audio player. The receiver receives a signal from the remote controller. The microprocessor executes a corresponding command according to a frequency of the signal by a pre-configured frequency spectrum table. The I/O controller controls the power source management module according to the command executed by the microprocessor. Thereby, the remote controller can remotely turning on or off the computer, and can perform some specific functions to make the computer much more functionally similar to, the electric appliance.

### BACKGROUND OF THE INVENTION

1. Field of the Invention

The present invention relates to a computer capable of being remotely controlled, and more particularly, to a computer remotely controlled by a remote controller, thereby allowing the computer to be an electric appliance.

2. Description of the Prior Art

When turning on or off a common computer, a user needs to directly press a power switch (or select the turning-off item in software manner). The user can then perform specific programs. For example, he can play audio CDs through a CD-ROM player of the computer to let the computer serve as a family audio. Or he can utilize the network interactive function of the computer to let the computer serve as an information appliance (IA).

However, above all operations must be manipulated by the user himself. This is different from a common electric, appliance, which can be turned on or off via a remote controller.

Accordingly, in order to allow a computer to be more-similar to the electric appliance, the above procedures of operating the computer by the user himself have inconvenience and drawbacks in practice. The present invention aims to resolve the problems in the prior art.

### SUMMARY OF THE INVENTION

The primary objective of the present invention is to provide a computer remotely controlled by a remote controller so as to provide a computer-like electric appliance. The computer is controlled by a remote controller to facilitate manipulation of the computer for a user and avoid the problem of manipulating the computer by the user himself. People not familiar with computer can also easily control the computer.

To achieve the above objective, the present invention mainly, provides a computer capable of being remotely turned on or off by a remote controller. The computer includes a receiver, a microprocessor, a power source management module, and an I/O controller. The receiver receives a signal from the remote controller. The microprocessor is, connected with the receiver, and executes a corresponding command according to the signal received by the receiver. The power source management module controls a power source state, i.e., on and off, of the computer. The I/O controller is connected with the microprocessor, and controls the power source management module according to the command executed by the microprocessor.

The various objects and advantages of the present invention will be more readily understood from the following detailed description when read in conjunction with the appended drawing, in which:

### BRIEF DESCRIPTION OF THE DRAWINGS

FIG. 1 is a circuit block diagram of the present invention.

### DETAILED DESCRIPTION OF THE PREFERRED EMBODIMENT

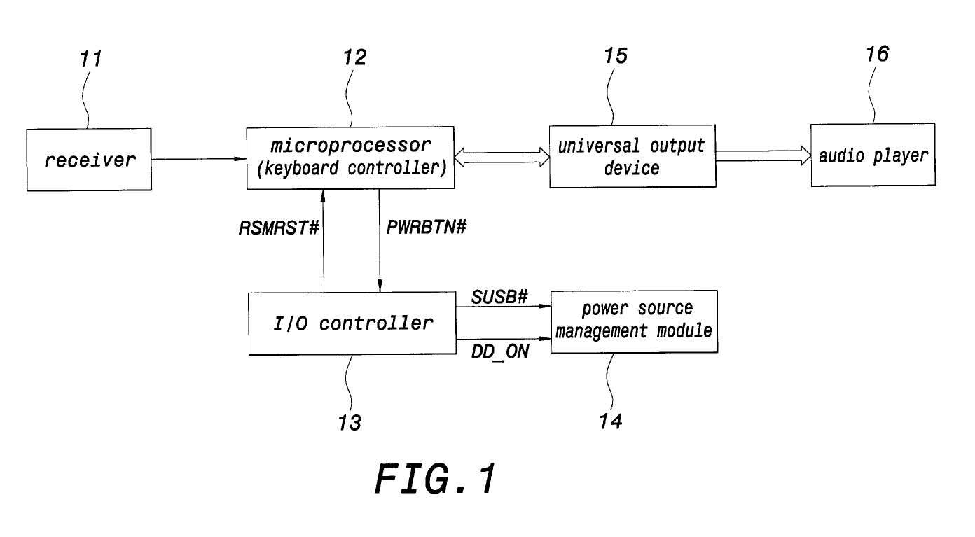

As shown in FIG. 1 of a circuit block diagram of the present invention, a computer remotely controlled by a remote controller includes a receiver 11, a microprocessor 12, an I/O controller 13, a power source management module 14, a universal output device 15, and an audio player 16.

The receiver 11 receives a message (signal) (like turning the power source of the computer on or off, play tracks, stop play, track forward, track reverse, track jump, volume adjust, mute, music selection, and so on) sent out by the remote controller, and sends out correspondingly different frequencies after reception to represent different commands. The receiver 11 is an infrared interface in the computer for receiving these signals.

The microprocessor 12 is connected with the receiver 11, and executes a corresponding command according to a frequency spectrum table, which is preconfigured by a program, after receiving a frequency sent out by the receiver 11. Preferably, the microprocessor 12 is a keyboard controller.

The I/O controller 13 is connected with the microprocessor 12. After the microprocessor 12 receives a command of turning on or off the power source, two signals RSMRST# and PWRBTN# between the microprocessor 12 and the I/O controller 13 will be pulled to the high level. When the two signals RSMRST# and PWRBTN# rise from the low level to the high level, two output signals SUSB# and DD-ON_ of the I/O controller 13 will be pulled to the high level.

The power source management module 14 is connected with the I/O controller 13, and is used to control the power source state of the computer. When the power source management module 14 detects that the two signals SUSB# and DD-ON_ outputted by the I/O controller 13 rise from the low level to the high level, it will turn on all power sources for the sake of turning on the computer.

The universal output device 15 is connected with the microprocessor 12. After the microprocessor 12 receives a command representing play tracks, pause, track forward, track reverse, disc eject, volume adjust, mute, or music selection, it will control the audio player 16 to perform corresponding operations like aforementioned play tracks, pause, track forward, track reverse, disc eject, volume adjust, mute, or music selection through the universal output device 15. The audio player 16 is connected with the universal output device 15. The audio player 16 is a CD-ROM player. Besides, the microprocessor 12 can also directly control an OP amplifier in the computer system to adjust the operation of volume adjust or mute after receiving the corresponding command of volume adjust or mute.

Thereby, a user can utilize the remote controller to turn on the power source of the computer so as to directly play an audio CD in a CD-ROM player, and can utilize the remote controller to directly control the operation of play tracks, pause, track forward, track reverse, disc eject, volume adjust, mute, or music selection, hence avoiding the trouble of manipulating the computer by the user himself. In order to use the computer more conveniently, a notebook computer is adapted as one preferred embodiment of the present invention.

To sum up, the computer remotely controlled by a remote controller serves like an electric appliance, and has the advantage of convenient manipulation. People not familiar with computer can also easily control the computer to perform desired functions through a remote controller.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A computer remotely controlled by a remote controller, said computer comprising:
a receiver for receiving a signal emitted by sad remote controller;
a microprocessor connected with said receiver for executing a corresponding command according to said signal received by said receiver;
a power source management module for controlling a power source state of said computer; and
an I/O controller connected with said microprocessor for controlling said power source management module according to said command executed by said microprocessor.

2. The computer as claimed in claim 1, wherein said computer is a notebook computer.

3. The computer as claimed in claim 1, wherein said commands are represented in terms of frequencies so that after said microprocessor receives one said frequency sent out by said receiver, said microprocessor will execute corresponding said command according to a frequency spectrum table preconfigured by a program.

4. The computer as claimed in claim 1, wherein said receiver comprises an infrared interface.

5. The computer as claimed in claim 1, wherein said microprocessor is a keyboard controller.

6. A computer remotely controlled by a remote controller, said computer comprising:
a receiver for receiving a signal from said remote controller;
a microprocessor connected with said receiver for executing a corresponding command according to said signal received by said receiver;
a power source management module for controlling a power source state of said computer;
an I/O controller connected with said microprocessor for controlling said power source management module according to said command executed by said microprocessor;
an audio player; and
a universal output device connected with said microprocessor for controlling said audio player according to said command executed by said microprocessor.

7. The computer as claimed in claim 6, wherein said computer is a notebook computer.

8. The computer claimed in claim 6, wherein said commands are represented in terms of frequencies so that after said microprocessor receives a frequency sent out by said receiver, said microprocessor will execute a corresponding command according to a frequency spectrum table preconfigured by a program.

9. The computer as claimed in claim 6, wherein said receiver comprises an infrared interface.

10. The computer as claimed in claim 6, wherein said microprocessor is a keyboard controller.

11. The computer as claimed in claim 6, wherein said audio player is a CD-ROM player.
